(19) United States
(12) Patent Application Publication
(10) Pub. No.: US 2023/0180430 A1
(43) Pub. Date: Jun. 8, 2023

(54) LIQUID COOLING PLATE RADIATOR AND COMPUTING DEVICE

(71) Applicant: SHENZHEN MICROBT ELECTRONICS TECHNOLOGY CO., LTD., GUANGDONG (CN)

(72) Inventors: Qian CHEN, GUANGDONG (CN); Fangyu LIU, GUANGDONG (CN); Yang GAO, GUANGDONG (CN); Yuefeng WU, GUANGDONG (CN); Haifeng GUO, GUANGDONG (CN)

(21) Appl. No.: 17/917,702

(22) PCT Filed: Jun. 9, 2021
(86) PCT No.: PCT/CN2021/099097

§ 371 Date: Oct. 7, 2022

(30) Foreign Application Priority Data
Sep. 14, 2020 (CN) 202010959810.5

(51) Int. Cl. H05K 7/20; G06F 1/20

(52) U.S. Cl. CPC H05K 7/20254; H05K 7/20272; H05K 7/205; G06F 1/20; G06F 2200/201

(57) ABSTRACT

This application discloses a liquid cooling plate radiator and a computing device adopting the liquid cooling plate radiator. The liquid cooling plate radiator includes: a radiator body; and a cooling liquid flow channel located in the radiator body, wherein a width of the cooling liquid flow channel is not less than a width of at least two chips arranged.

### CROSS-REFERENCE TO RELATED APPLICATIONS

This application is a national stage of International Application No. PCT/CN2021/099097, filed on Jun. 9, 2021, which claims priority to Chinese Patent Application No. 202010959810.5, filed on Sep. 14, 2020. Both of the aforementioned applications are hereby incorporated by reference in their entireties.

### TECHNICAL FIELD

This application relates to the field of heat dissipation technology, and in particular, to a liquid cooling plate radiator and a computing device adopting the liquid cooling plate radiator.

### BACKGROUND

An electronic computing device, such as a virtual currency mining machine, often adopts a large number of chips to perform computing tasks. In the structural design, the large number of chips are arranged in rows and columns on PCBs (printed circuit boards), and this arrangement in rows and columns is conducive to the wiring of power supply and signals. During operation, the large number of chips produce a huge amount of heat, and therefore it is necessary to dissipate the produced heat in time, so that the chips can always be in the temperature range required for operation, to avoid downtime caused by overheating.

### SUMMARY

In an aspect, embodiments of this application provide a liquid cooling plate radiator comprising:
a radiator body; and
a cooling liquid flow channel located in the radiator body, wherein a width of the cooling liquid flow channel is not less than a width of at least two chips arranged.

Further, on the same end surface of the radiator body, there are two flow channel openings in communication with the cooling liquid flow channel.

Further, there is at least one cooling liquid flow channel, and the cooling liquid flow channel extends straight in the radiator body;
when there are at least two cooling liquid flow channel, the cooling liquid flow channels are arranged parallel to each other.

Further, the number of the cooling liquid flow channels is an even number, and the adjacent cooling liquid flow channels are in communication with each other through their respective end portions to form a serial flow channel;
end portions of two cooling liquid flow channels at a head and at a tail in the serial flow channel extend respectively to the same end surface of the radiator body to form the two flow channel openings, the end portions extending respectively to the same end surface of the radiator body not in communication with other cooling liquid flow channels.

Further, the number of the cooling liquid flow channels is an odd number greater than one, and the adjacent cooling liquid flow channels are in communication with each other through their respective end portions to form a serial flow channel;
an end portion of a cooling liquid flow channel at one end of the serial flow channel extends to an end surface of the radiator body to form one of the two flow channel openings, the end portion extending to the end surface of the radiator body not in communication with other cooling liquid flow channels;
the liquid cooling plate radiator further comprises a flow directing channel located in the radiator body that is adjacent to and parallel to a cooling liquid flow channel at the other end of the serial flow channel;
an end portion of the cooling liquid flow channel at the other end is in communication with one end portion of the flow directing channel, the end portion in communication with one end portion of the flow directing channel not in communication with other cooling liquid flow channels;
the other end portion of the flow directing channel extends to the end surface of the radiator body to form the other of the two flow channel openings.

Further, there is one cooling liquid flow channel;
the liquid cooling plate radiator further comprises a flow directing channel located in the radiator body and parallel to the cooling liquid flow channel;
end portions at one side of the cooling liquid flow channel and the flow directing channel are in communication with each other;
end portions at the other side of the cooling liquid flow channel and the flow directing channel extend to the same end surface of the radiator body to form the two flow channel openings.

Further, there are at least two cooling liquid flow channels;
end portions at one side of the at least two cooling liquid flow channels are in communication with each other, end portions at the other side of the at least two cooling liquid flow channels are in communication with each other, and thus the at least two cooling liquid flow channels form a parallel flow channel;
an end portion at the other side of a cooling liquid flow channel at one edge of the parallel flow channel extends to an end surface of the radiator body to form one of the two flow channel openings;
the liquid cooling plate radiator further comprises a flow directing channel located in the radiator body that is adjacent to and parallel to a cooling liquid flow channel at the other edge of the parallel flow channel;
end portions at the one side of the flow directing channel and the cooling liquid flow channel at the other edge are in communication with each other;
an end portion at the other side of the flow directing channel extends to the end surface of the radiator body to form the other of the two flow channel openings.

Further, the liquid cooling plate radiator further comprises:
two pipe fitting connector, the two pipe fitting connectors adapted respectively to the two flow channel openings and mounted respectively at the two flow channel openings.

Further, the pipe fitting connector is a hollow pipe structure, and the pipe fitting connector comprises a first connection portion, a transition portion, and a second connection portion that are integrally formed; wherein,
a shape of a cross section of an inner hole of the first connection portion matches a shape of the flow channel opening, the first connection portion docked with the flow channel opening;
the second connection portion matches a connected pipe fitting;
the transition portion is located between the first connection portion and the second connection portion; and
at a first junction of the transition portion and the second connection portion, a cross section of an inner hole of the transition portion has the same shape as a cross section of an inner hole of the second connection portion;
at a second junction of the transition portion and the first connection portion, the cross section of the inner hole of the transition portion has the same shape as the cross section of the inner hole of the first connection portion;
in the transition portion, from the first junction to the second junction, the cross section of the inner hole of the transition portion smoothly transits from a shape of the cross section of the inner hole of the second connection portion to the shape of the cross section of the inner hole of the first connection portion.

Further, the shape of the cross section of the inner hole of the first connection portion is a flat oval or a rectangle; and
the shape of the cross section of the inner hole of the second connection portion is a circle.

In another aspect, embodiments of this application provide a computing device comprising:
the liquid cooling plate radiator according to any described above;
a PCB board provided with at least two chip voltage layers at one side surface thereof facing the liquid cooling plate radiator, wherein each chip voltage layer comprises at least two chips that are powered in parallel and arranged in a row, the chips are attached to the liquid cooling plate radiator, and the chips are stacked on the cooling liquid flow channel, the chips in each chip voltage layer are arranged in a direction perpendicular to an extension direction of the cooling liquid flow channel, and the chips in each chip voltage layer are located on the same cooling liquid flow channel.

Further, the at least two chip voltage layers are distributed along the extension direction of the cooling liquid flow channel.

It can be seen from the above solutions that in the liquid cooling plate radiator and the computing device of this application, the structural design of the cooling liquid flow channel in the radiator body is utilized to ensure that the chips in each chip voltage layer are located on the same cross section perpendicular to the extension direction of the cooling liquid flow channel in the liquid cooling plate radiator. When the cooling liquid in the cooling liquid flow channel flows through the same cross section, the temperature of the cooling liquid thereat is consistent, ensuring that the temperatures of the respective chips arranged at the same cross section and located in the same chip voltage layer are basically consistent, such that the balanced stability of the operating frequency of each chip in each voltage layer can be facilitated, their optimal operating state can be achieved through adjustment simultaneously, and thus the performance of the entire electronic computing device can be maximized.

### BRIEF DESCRIPTION OF THE DRAWINGS

FIG. 1 is a schematic diagram of an arrangement structure of chips on a PCB board.

FIG. 2 is a schematic diagram of a power supply structure of the chips in FIG. 1.

FIG. 3 is a schematic diagram of a pipeline path arranged for the structure in FIG. 1 according to the related technical solution.

FIG. 4 is a schematic structural diagram of a liquid cooling plate radiator according to an embodiment of this application.

FIG. 5 is a schematic cross-sectional structural diagram of a liquid cooling plate radiator according to an embodiment of this application.

FIG. 6 is a schematic diagram of a pipeline path in a liquid cooling plate radiator according to an embodiment of this application.

FIG. 7 is a schematic diagram of a chip distribution structure to which the pipeline path in FIG. 6 is adapted.

FIG. 8 is a schematic diagram of a pipeline path in a liquid cooling plate radiator according to an embodiment of this application.

FIG. 9 is a schematic diagram of a chip distribution structure to which the pipeline path in FIG. 8 is adapted.

FIG. 10 is a schematic diagram of a pipeline path in a liquid cooling plate radiator according to an embodiment of this application.

FIG. 11 is a schematic diagram of a chip distribution structure to which the pipeline path in FIG. 10 is adapted.

FIG. 12 is a schematic diagram of a pipeline path in a liquid cooling plate radiator according to an embodiment of this application.

FIG. 13 is a schematic diagram of a chip distribution structure to which the pipeline path in FIG. 12 is adapted.

FIG. 14 is a schematic cross-sectional diagram of a liquid cooling plate radiator in a specific embodiment.

FIG. 15 is a schematic structural diagram of a radiator body and a flow channel opening according to an embodiment of this application.

FIG. 16 is a schematic diagram of a pipe fitting connector according to an embodiment of this application.

FIG. 17 is a schematic perspective structural diagram of a pipe fitting connector according to an embodiment of this application.

FIG. 18 is a schematic perspective structural diagram of one side of a first connection portion of a pipe fitting connector according to an embodiment of this application.

FIG. 19 is a schematic top structural diagram of a pipe fitting connector mounted on a radiator body according to an embodiment of this application.

FIG. 20 is a schematic perspective structural diagram of a pipe fitting connector mounted on a radiator body with a cooling liquid flow channel according to an embodiment of this application.

In the drawings, the reference numbers represent the following parts:
1. radiator body
2. cooling liquid flow channel
31. first flow channel opening
32. second flow channel opening
4. flow directing channel
5. pipe fitting connector
51. first connection portion
52. transition portion
53. second connection portion
100. PCB board
200. chip
300. heat pipe.

### DETAILED DESCRIPTION

To make the objectives, technical solutions, and advantages of this application clearer and more comprehensible, the following further describes this application in detail with reference to the accompanying drawings and embodiments.

In order to dissipate heat from chips in electronic devices, there is a PCB (Printed Circuit Board) heat dissipation component in the related art. The PCB heat dissipation component can be used to dissipate heat from a large number of chips arranged in rows and columns. It uses a heat conducting plate and a flat pipe to connect the chips arranged in rows and columns in series on a path of the flat pipe, and uses a liquid cooling medium flowing through the flat pipe to remove the heat of the chips.

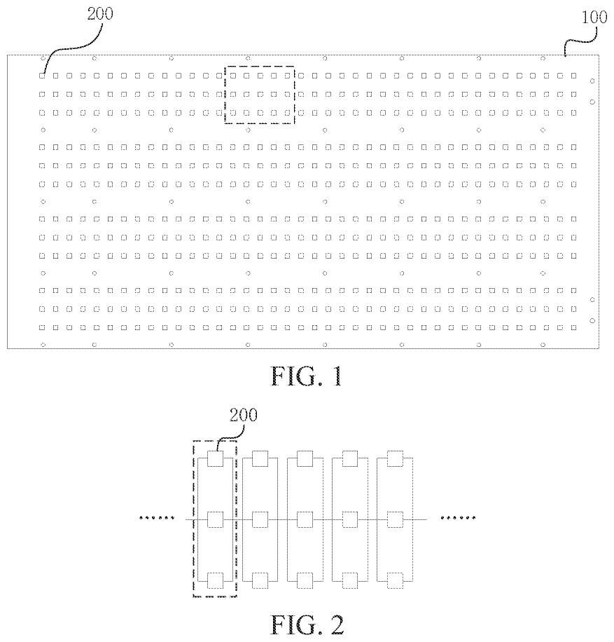

With increasingly improvements of computing requirements, the wiring of the power supply part and the signal part in the electronic computing device is being constantly improved, that is, the signal and power supply structures are being constantly innovated. For example, the Chinese Patent No. CN207531168U discloses a solution for supplying power to multi-voltage layers of a large number of chips. Using this solution, a large number of chips arranged in rows and columns on the PCB can be divided into several groups in terms of the power supply structure, a series power supply mode is used between the several groups, and a parallel mode is used between the chips in the group. Correspondingly, FIG. 1 of this application shows an arrangement structure of chips on a PCB board, where many squares represent chips 200 arranged in rows and columns on a PCB board 100. FIG. 2 shows a power supply structure of any region in FIG. 1, for example, a region in the dashed box in FIG. 1. As shown in FIG. 1 and FIG. 2, a large number of chips are divided into a plurality of voltage layers in the chip arrangement structure. For example, as shown in FIG. 2, each voltage layer includes three chips 200, where the three chips 200 in the dashed box are chips located in the same voltage layer, and a serial connection structure is used in the power supply circuit between the voltage layers. For example, each voltage layer is connected in series between high voltage and grounding end. Theoretically, the operating voltages of each chip 200 in each voltage layer can be kept the same in this structure.

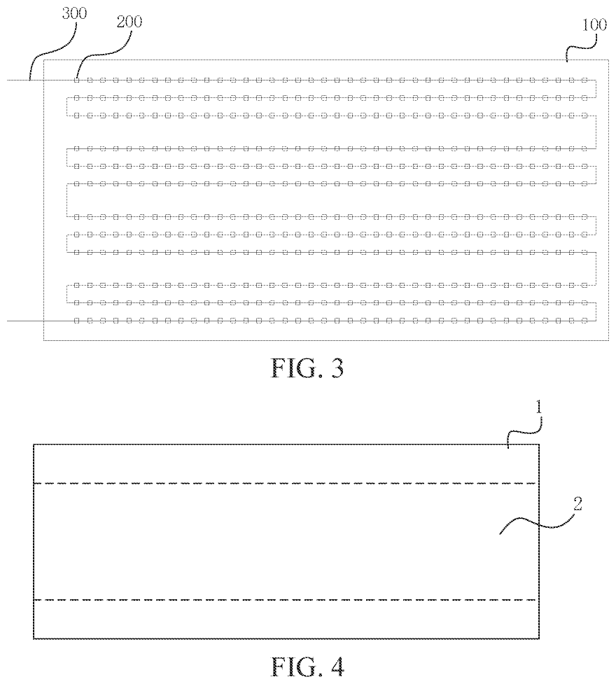

The path of arranging pipelines for the structure shown in FIG. 1 according to the PCB heat dissipation component solution in the above related art can be referred to FIG. 3 In practice, it is found that, by dissipating heat in this way, there are still some differences in performance among the chips 200 in the voltage layers.

Specifically, as shown in FIG. 1, FIG. 2, and FIG. 3, the different chips 200 in the same voltage layer are not at the same cross section in the arrangement path of a heat pipe 300, and when the liquid cooling medium flows through the chips 200 in sequence, it takes away the heat of the chips 200. Consequently, in the path of the liquid cooling medium flowing through the first chip 200 to the last chip 200, the temperature of the liquid cooling medium (or the heat pipe 300) is increasing. This is because as the number of the chips 200 through which the liquid cooling medium flows increases, the liquid cooling medium gains more heat, and the cooling effect of the liquid cooling medium on the chips 200 is weakened. Therefore, in the path through which the liquid cooling medium flows, the temperature of the chip 200 from the first chip 200 to the last chip 200 through which the liquid cooling medium flows is in a gradually increasing trend. As shown in FIG. 2, there are large differences in temperature between the different chips 200 in the same voltage layer. Since the performance of the chip is affected by its temperature, the temperature differences between the different chips 200 in the same voltage layer can lead to performance differences between the chips 200, and then low performance chips encumbers the operation of high performance chips, which reduces the overall performance of the entire electronic computing device.

In some embodiments, the reason why the temperature differences between the different chips 200 in the same voltage layer may cause the reduction of the overall performance of the chips in the same voltage layer is that: the chips in the same voltage layer are connected in parallel, and the chips have the same power supply voltage. For the chip, the higher the temperature, the higher the frequency, and the higher the frequency, the greater the power consumption, resulting in greater heat generation, which further increases the temperature of the chip, forming a vicious circle between temperature and frequency. At the same time, the total current of the same voltage layer is constant. In this case, the higher the chip frequency, the higher the power consumption and the higher the current, which further reduces the current of other chips with lower temperature in the same voltage layer, pulling down the operating frequency of other chips with lower temperature in the same voltage layer. Finally, the operating frequency of the chips in the same voltage layer cannot be at the optimal operating frequency, and the overall performance of the chips in the same voltage layer cannot be in the optimal state.

Therefore, the embodiments of this application provide a new liquid cooling plate radiator and a computing device adopting the liquid cooling plate radiator to keep the same temperature between different chips in the same voltage layer, thereby improving the overall performance of all chips in the same voltage layer and ensuring the improved performance of the entire electronic computing device.

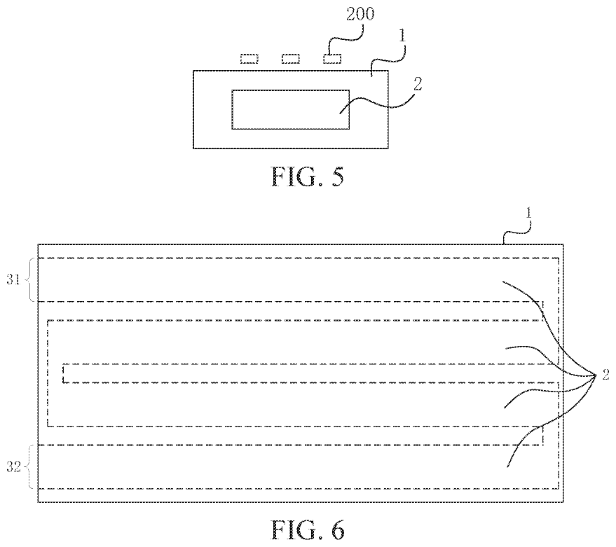

FIG. 4 is a schematic structural diagram of a liquid cooling plate radiator according to an embodiment of this application, and FIG. 5 is a schematic cross-sectional structural diagram thereof. As shown in FIG. 4 and FIG. 5, the liquid cooling plate radiator in the embodiment of this application includes a radiator body 1 and a cooling liquid flow channel 2. Wherein, the cooling liquid flow channel 2 is located in the radiator body 1, as shown in FIG. 4, the cooling liquid flow channel 2 is the region between the two dashed lines. It should be noted that, the cooling liquid flow channel 2 is disposed inside the radiator body 1, that is, the liquid cooling plate radiator in the embodiment of this application has a hollow structure, and the cross-sectional structure shown in FIG. 5 is a schematic structure of the cross section perpendicular to the extension direction of the cooling liquid flow channel 2. In the embodiment of this application, a width of the cooling liquid flow channel 2 corresponds to a width occupied by the chips in the same voltage layer. As an example, when the same voltage layer includes at least two chips 200, the width of the cooling liquid flow channel 2 matches a width of the at least two chips 200 arranged. For example, the width of the cooling liquid flow channel 2 is equal to or slightly greater than the width of the at least two chips 200 arranged. For example, the dashed box in FIG. 5 represents the chip 200. In this way, a plurality of chips 200 (for example, the three chips 200 as shown in FIG. 5) can be arranged at the same cross section perpendicular to the extension direction of the cooling liquid flow channel 2 at the same time, so that when the cooling liquid flows through the cross section, the temperature of the cooling liquid thereat is consistent, which can ensure that the temperature of the plurality of the chips 200 arranged at the same cross section at the same time can be kept basically the same.

In some embodiments, on the same end surface of the radiator body 1, there are two flow channel openings in communication with the cooling liquid flow channel 2. Since the flow channel openings for in and out of the cooling liquid need to be provided on the liquid cooling plate radiator to ensure that the cooling liquid can flow into the cooling liquid flow channel 2 from one flow channel opening and out of the cooling liquid flow channel 2 from the other flow channel opening, proper positions of the flow channel openings need to be designed in the liquid cooling plate radiator. Based on this, in some embodiments, the two flow channel openings in communication with the cooling liquid flow channel 2 are provided on the same end surface of the radiator body 1, so that the liquid cooling plate radiator can be connected with an outside cooling liquid pipeline on the same end surface of the radiator body 1, and based on this, the outside cooling liquid pipeline can be designed at the same side of the liquid cooling plate radiator. Compared to the structure in which the flow channel openings are provided respectively on different end surfaces of the radiator body 1, the flow channel openings provided on the same end surface of the radiator body 1 can save the space for arranging the cooling liquid pipeline, and based on this, the occupied space of the computing device adopting the liquid cooling plate radiator according to the embodiment of this application can be further reduced to further miniaturize and integrate the computing device. Meanwhile, based on the structure in which the flow channel openings are provided on the same end surface of the radiator body 1, the circuit interface of the PCB board of the liquid cooling plate radiator can be provided at the other side opposite to the flow channel openings, so that the mutual interference caused by the circuit interface and the flow channel opening located on the same side can be avoided, leaving more space for the circuit interface side, which is also conducive to the management and maintenance of the circuit interface in the PCB board.

In combination with the circuit structure and the arrangement structure in rows and columns of the chips on the PCB board, in a further embodiment of this application, the number of the cooling liquid flow channels 2 is at least one, each cooling liquid flow channel 2 can extend straight in the radiator body 1, and when the number of the cooling liquid flow channels 2 is at least two, the cooling liquid flow channels 2 can be set in parallel, or substantially parallel, to each other. In other embodiments, in combination with other arrangement structures of the chips on the PCB board, such as diagonal arrangement, the cooling liquid flow channels 2 are arranged according to the corresponding arrangement structure, and when the number of the cooling liquid flow channels 2 is at least two, the cooling liquid flow channels 2 may not be in parallel to each other.

In the embodiment of this application, when the number of the cooling liquid flow channels 2 is at least two, the cooling liquid flow channels 2 can be connected in series or parallel, which is a serial flow channel or a parallel flow channel.

Since the two flow channel openings in communication with the cooling liquid flow channel 2 are located on the same end surface of the radiator body 1, for the different numbers and series-parallel connection manners of the cooling liquid flow channels 2, the structures are slightly different, which is specifically described in combination with embodiments.

In some embodiments, the number of the cooling liquid flow channels 2 is an even number, and the adjacent cooling liquid flow channels 2 are in communication with each other through their respective end portions to form a serial flow channel. End portions of two cooling liquid flow channels 2 at a head and at a tail in the serial flow channel that are not in communication with other cooling liquid flow channels 2 extend to the same end surface of the radiator body 1, to form the two flow channel openings.

For example, as shown in FIG. 6, the number of the cooling liquid flow channels 2 is four. The cooling liquid flow channels 2 from the uppermost side to the lowermost side in FIG. 6 are named as a first cooling liquid flow channel, a second cooling liquid flow channel, a third cooling liquid flow channel, and a fourth cooling liquid flow channel, respectively. The adjacent cooling liquid flow channels 2 are in communication with each other through their respective end portions to form a serial flow channel. For example, as shown in FIG. 6, the first cooling liquid flow channel is adjacent to the second cooling liquid flow channel, the second cooling liquid flow channel is adjacent to the third cooling liquid flow channel, the third cooling liquid flow channel is adjacent to the fourth cooling liquid flow channel, the first cooling liquid flow channel is in communication with the right end portion of the second cooling liquid flow channel, the second cooling liquid flow channel is in communication with the left end portion of the third cooling liquid flow channel, and the third cooling liquid flow channel is in communication with the right end portion of the fourth cooling liquid flow channel. In this way, the first cooling liquid flow channel, the second cooling liquid flow channel, the third cooling liquid flow channel, and the fourth cooling liquid flow channel form the serial flow channel. The two cooling liquid flow channels 2 at the head and at the tail in the serial flow channel are the first cooling liquid flow channel and the fourth cooling liquid flow channel, the end portion of the first cooling liquid flow channel that is not in communication with other cooling liquid flow channels 2 is the left end portion of the first cooling liquid flow channel, the end portion of the fourth cooling liquid flow channel that is not in communication with other cooling liquid flow channels 2 is the left end portion of the fourth cooling liquid flow channel, and the left end portion of the first cooling liquid flow channel and the left end portion of the fourth cooling liquid flow channel extend to the same end surface at the left side of the radiator body 1 to form two flow channel openings, that is, a first flow channel opening 31 and a second flow channel opening 32.

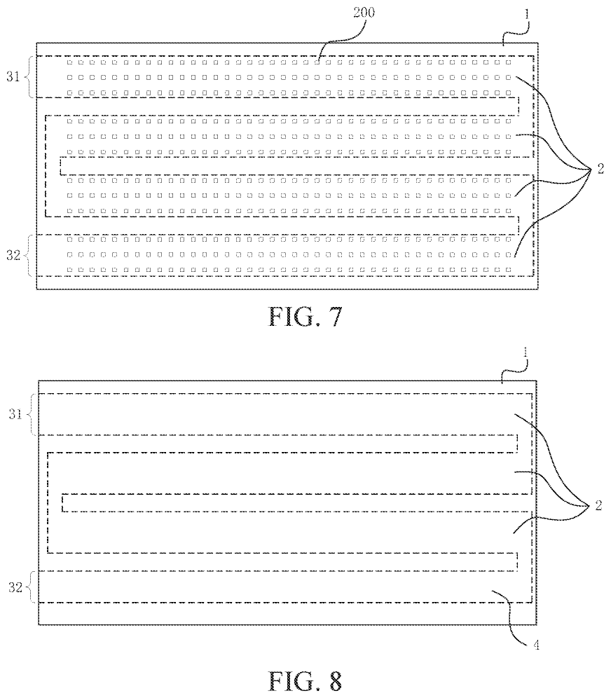

A chip distribution structure to which the pipeline path as shown in FIG. 6 is adapted can be referred to FIG. 7. As shown in FIG. 7, in the embodiment of this application, three chips 200 are arranged at the same cross section perpendicular to the extension direction of each cooling liquid flow channel 2 at the same time. When the cooling liquid in the cooling liquid flow channel 2 flows through the same cross section, the temperature of the cooling liquid thereat is consistent, ensuring that the temperatures of the three chips 200 arranged at the same cross section can be kept basically the same. Meanwhile, in combination with the chip power supply structure shown in FIG. 2, the three chips 200 arranged at the same cross section are located in the same chip voltage layer. In this way, it is ensured that the temperatures of the three chips 200 in the same chip voltage layer are kept the same. It can be seen from FIG. 7, for each chip voltage layer, the liquid cooling plate radiator in the embodiment of this application can ensure that all the chips 200 therein are located at the same cross section of the cooling liquid flow channel 2, so that the temperatures of all the chips 200 in the chip voltage layer are kept the same. Therefore, the liquid cooling plate radiator in the embodiment of this application can facilitate the balanced stability of the operating frequency of each chip in each voltage layer, achieve the optimal operating state through adjustment simultaneously, and thus maximize the performance of the entire electronic computing device.

It should be noted that, FIG. 7 is only an exemplary description. The number of the chips 200 in the same chip voltage layer may also be two, four, five, six, or more, and all the chips 200 in the same chip voltage layer are located at the same cross section of the cooling liquid flow channel 2.

In some embodiments, the number of the cooling liquid flow channels 2 may be an odd number greater than one, and the adjacent cooling liquid flow channels 2 are in communication with each other through their respective end portions to form a serial flow channel. An end portion of a cooling liquid flow channel 2 located at one end of the serial flow channel extends to an end surface of the radiator body 1, to form one of the two flow channel openings, where the end portion extending to the end surface of the radiator body is not in communication with other cooling liquid flow channels 2.

The liquid cooling plate radiator further includes a flow directing channel located in the radiator body, and the flow directing channel is adjacent to and parallel to a cooling liquid flow channel 2 located at the other end of the serial flow channel. An end portion of the cooling liquid flow channel 2 at the other end is in communication with one end portion of the flow directing channel, and the end portion in communication with the one end portion of the flow directing channel is not in communication with other cooling liquid flow channels. The other end portion of the flow directing channel extends to the end surface of the radiator body, to form the other of the two flow channel openings.

For example, as shown in FIG. 8, the number of the cooling liquid flow channels 2 is three. The cooling liquid flow channels 2 from the uppermost side to the lowermost side in FIG. 8 are named as a first cooling liquid flow channel, a second cooling liquid flow channel, and a third cooling liquid flow channel, respectively. The adjacent cooling liquid flow channels 2 are in communication with each other through their respective end portions to form a serial flow channel. For example, as shown in FIG. 8, the first cooling liquid flow channel is adjacent to the second cooling liquid flow channel, the second cooling liquid flow channel is adjacent to the third cooling liquid flow channel, the first cooling liquid flow channel is in communication with the right end portion of the second cooling liquid flow channel, the second cooling liquid flow channel is in communication with the left end portion of the third cooling liquid flow channel. In this way, the first cooling liquid flow channel, the second cooling liquid flow channel, and the third cooling liquid flow channel form the serial flow channel. A cooling liquid flow channel 2 located at one end of the serial flow channel is the first cooling liquid flow channel, an end portion of the cooling liquid flow channel 2 at the one end of the serial flow channel that is not in communication with other cooling liquid flow channels 2 is the left end portion of the first cooling liquid flow channel, and the left end portion of the first cooling liquid flow channel extends to the left end surface of the radiator body 1, to form one of the two flow channel openings, that is, the first flow channel opening 31. A cooling liquid flow channel 2 located at the other end of the serial flow channel is the third cooling liquid flow channel. As shown in FIG. 8, a flow directing channel 4 is adjacent to and parallel to the third cooling liquid flow channel. An end portion of the cooling liquid flow channel 2 located at the other end of the serial flow channel that is not in communication with other cooling liquid flow channels is the right end portion of the third cooling liquid flow channel. Correspondingly, one end portion of the flow directing channel 4 in communication with it is the right end portion of the flow directing channel 4. That is, the right end portion of the third cooling liquid flow channel is in communication with the right end portion of the flow directing channel 4. The other end portion of the flow directing channel 4 is the left end portion. The left end portion of the flow directing channel 4 extends to the left end surface of the radiator body 1, to form the other of the two flow channel openings, that is, the second flow channel opening 32.

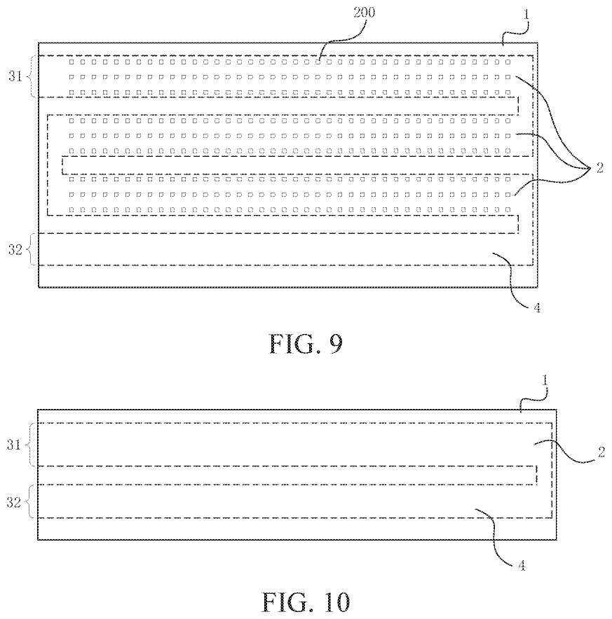

A chip distribution structure to which the pipeline path as shown in FIG. 8 is adapted can be referred to FIG. 9. As shown in FIG. 9, in the embodiment of this application, three chips 200 are arranged at the same cross section perpendicular to the extension direction of each cooling liquid flow channel 2 at the same time. When the cooling liquid in the cooling liquid flow channel 2 flows through the same cross section, the temperature of the cooling liquid thereat is consistent, ensuring that the temperatures of the three chips 200 arranged at the same cross section can be kept basically the same. Meanwhile, in combination with the chip power supply structure shown in FIG. 2, the three chips 200 arranged at the same cross section are located in the same chip voltage layer. In this way, it is ensured that the temperatures of the three chips 200 in the same chip voltage layer are kept the same. It can be seen from FIG. 9, for each chip voltage layer, the liquid cooling plate radiator in the embodiment of this application can ensure that all the chips 200 therein are at the same cross section of the cooling liquid flow channel 2, so that the temperatures of all the chips 200 in the chip voltage layer are kept the same. Therefore, the liquid cooling plate radiator in the embodiment of this application can facilitate the balanced stability of the operating frequency of each chip in each voltage layer, achieve the optimal operating state through adjustment simultaneously, and maximize the performance of the entire electronic computing device.

In the example shown in FIG. 8, the flow directing channel 4 is an additional structure added for arranging the first flow channel opening 31 and the second flow channel opening 32 on the same end surface of the radiator body 1, and its function is to guide the flow directing path (communicating the cooling liquid after flowing through the cooling liquid flow channels with the outside pipeline) to the same end surface provided with the first flow channel opening 31. Generally, no chip 200 is arranged on the flow directing channel 4. However, since the flow directing channel 4 is also located in the radiator body 1 and also has the heat conduction function, an chip 200 can also be arranged at a corresponding position on the flow directing channel 4 based on the circuit design requirement.

It should be noted that, FIG. 9 is only an exemplary description. The number of the chips 200 in the same chip voltage layer may also be two, four, five, six, or more, and all the chips 200 in the same chip voltage layer are located at the same cross section of the cooling liquid flow channel 2.

In some embodiments, as shown in FIG. 10, the number of the cooling liquid flow channel 2 is one. The liquid cooling plate radiator further includes a flow directing channel 4 located in the radiator body 1 and parallel to the cooling liquid flow channel 2. End portions at one side of the cooling liquid flow channel 2 and the flow directing channel 4 are in communication with each other. For example, as shown in FIG. 10, the end portions at one side of the cooling liquid flow channel 2 and the flow directing channel 4 are end portions towards the right direction of the cooling liquid flow channel 4 and the flow directing channel 2. The end portions towards the right direction of the cooling liquid flow channel 2 and the flow directing channel 4 are in communication with each other. End portions at the other side of the cooling liquid flow channel 2 and the flow directing channel 4, that is, end portions towards the other direction of the cooling liquid flow channel 2 and the flow directing channel 4, extend to the same end surface of the radiator body 1, to form two flow channel openings. For example, as shown in FIG. 10, end portions towards the left direction of the cooling liquid flow channel 2 and the flow directing channel 4 extend to the left end surface of the radiator body 1, to form the first flow channel opening 31 and the second flow channel opening 32.

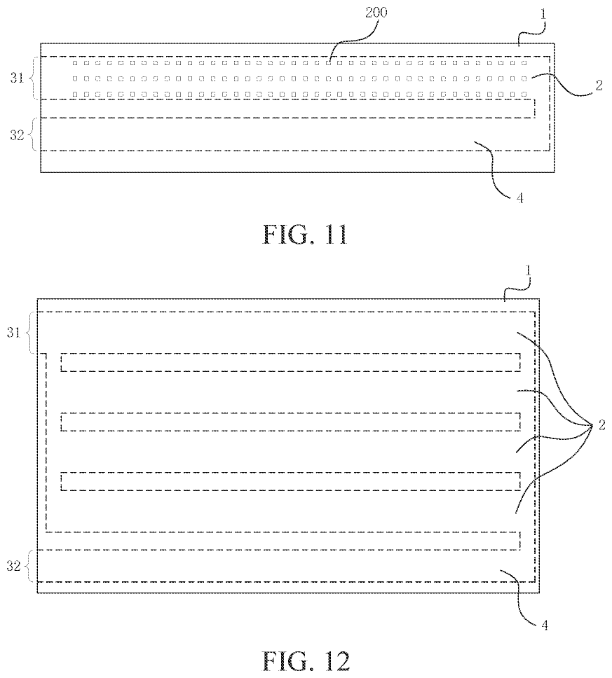

A chip distribution structure to which the pipeline path in FIG. 10 is adapted can be referred to FIG. 11. As shown in FIG. 11, in the embodiment of this application, three chips 200 are arranged at the same cross section perpendicular to the extension direction of each cooling liquid flow channel 2 at the same time. When the cooling liquid in the cooling liquid flow channel 2 flows through the same cross section, the temperature of the cooling liquid thereat is consistent, ensuring that the temperatures of the three chips 200 arranged at the same cross section can be kept basically the same. Meanwhile, in combination with the chip power supply structure shown in FIG. 2, the three chips 200 arranged at the same cross section are located in the same chip voltage layer. In this way, it is ensured that the temperatures of the three chips 200 in the same chip voltage layer are kept the same. It can be seen from FIG. 11, for each chip voltage layer, the liquid cooling plate radiator in the embodiment of this application can ensure that all the chips 200 therein are at the same cross section of the cooling liquid flow channel 2, so that the temperatures of all the chips 200 in the chip voltage layer are kept the same. Therefore, the liquid cooling plate radiator in the embodiment of this application can facilitate the balanced stability of the operating frequency of each chip in each voltage layer, achieve the optimal operating state through adjustment simultaneously, and thus maximize the performance of the entire electronic computing device.

In the example shown in FIG. 10, the flow directing channel 4 is an additional structure added for arranging the first flow channel opening 31 and the second flow channel opening 32 on the same end surface of the radiator body 1, and its function is to guide the flow directing path (communicating the cooling liquid after flowing through the cooling liquid flow channels with the outside pipeline) to the same end surface provided with the first flow channel opening 31. Generally, no chip 200 is arranged on the flow directing channel 4. However, since the flow directing channel 4 is also located in the radiator body 1 and also has the heat conduction function, a chip 200 can also be arranged at a corresponding position on the flow directing channel 4 based on the circuit design requirement.

It should be noted that, FIG. 11 is only an exemplary description. The number of the chips 200 in the same chip voltage layer may also be two, four, five, six, or more, and all the chips 200 in the same chip voltage layer are located at the same cross section of the cooling liquid flow channel 2.

In some embodiments, the number of the cooling liquid flow channels 2 is at least two. End portions at one side of the at least two cooling liquid flow channels 2 are in communication with each other, end portions at the other side of the at least two cooling liquid flow channels 2 are in communication with each other, and thus the at least two cooling liquid flow channels 2 form a parallel flow channel. An end portion at the other side of a cooling liquid flow channel at one edge of the parallel flow channel extends to the end surface of the radiator body 1, to form one of the two flow channel openings. The liquid cooling plate radiator further includes a flow directing channel located in the radiator body 1, and the flow directing channel is adjacent to and parallel to a cooling liquid flow channel at the other edge of the parallel flow channel. End portions at the one side of the flow directing channel and the cooling liquid flow channel at the other edge are in communication with each other. The end portion at the other side of the flow directing channel extends to the end surface of the radiator body 1, to form the other of the two flow channel openings.

For example, as shown in FIG. 12, the number of the cooling liquid flow channels 2 is four. End portions at one side of the four cooling liquid flow channels 2 are in communication with each other, and end portions at the other side of the four cooling liquid flow channels 2 are in communication with each other. That is, the end portions towards the right direction of the four cooling liquid flow channels 2 are in communication with each other, and the end portions towards the left direction of the four cooling liquid flow channels 2 are in communication with each other, and thus the four cooling liquid flow channels 2 form a parallel flow channel. The end portion at the other side of the cooling liquid flow channel at an upper edge of the parallel flow channel, that is, the end portion towards the left direction of the cooling liquid flow channel 2 at the upper edge of the parallel flow channel, extends to the end surface of the radiator body 1, to form one of the two flow channel openings, that is, the first flow channel opening 31. The flow directing channel 4 is adjacent to and parallel to the cooling liquid flow channel 2 at a lower edge of the parallel flow channel. End portions at the one side of the flow directing channel 4 and the cooling liquid flow channel at the other edge are in communication with each other, that is, end portions towards the right direction of the flow directing channel 4 and the cooling liquid flow channel 2 at the lower edge are in communication with each other. The end portion towards the left direction of the flow directing channel 4 extends to the end surface of the radiator body 1, to form the other of the two flow channel openings, that is, the second flow channel opening 32.

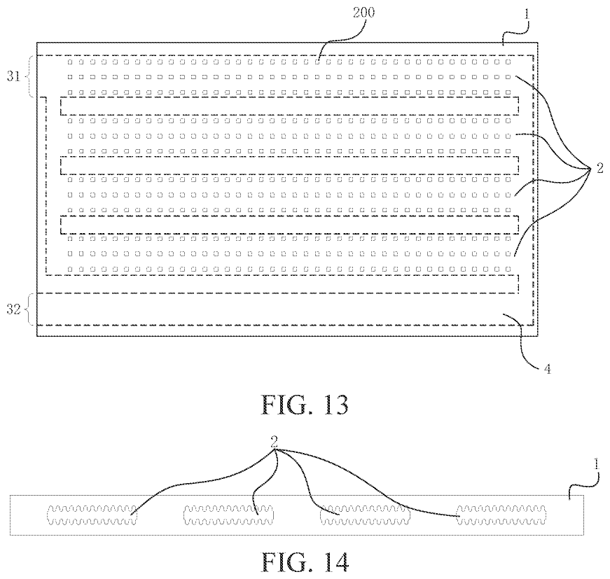

A chip distribution structure to which the pipeline path as shown in FIG. 12 is adapted can be referred to FIG. 13. As shown in FIG. 13, in the embodiment of this application, three chips 200 are arranged at the same cross section perpendicular to the extension direction of each cooling liquid flow channel 2 at the same time. When the cooling liquid in the cooling liquid flow channel 2 flows through the same cross section, the temperature of the cooling liquid thereat is consistent, ensuring that the temperatures of the three chips 200 arranged at the same cross section can be kept basically the same. Meanwhile, in combination with the chip power supply structure shown in FIG. 2, the three chips 200 arranged at the same cross section are located in the same chip voltage layer. In this way, it is ensured that the temperatures of the three chips 200 in the same chip voltage layer are kept the same. It can be seen from FIG. 13, for each chip voltage layer, the liquid cooling plate radiator in the embodiment of this application can ensure that all the chips 200 therein are at the same cross section of the cooling liquid flow channel 2, so that the temperatures of all the chips 200 in the chip voltage layer are kept the same. Therefore, the liquid cooling plate radiator in the embodiment of this application can facilitate the balanced stability of the operating frequency of each chip in each voltage layer, achieve the optimal operating state through adjustment simultaneously, and maximize the performance of the entire electronic computing device.

In the example shown in FIG. 12, the flow directing channel 4 is an additional structure added for arranging the first flow channel opening 31 and the second flow channel opening 32 on the same end surface of the radiator body 1, and its function is to guide the flow directing path (communicating the cooling liquid after flowing through the cooling liquid flow channels with the outside pipeline) to the same end surface provided with the first flow channel opening 31. Generally, no chip 200 is arranged on the flow directing channel 4. However, since the flow directing channel 4 is also located in the radiator body 1 and also has the heat conduction function, an chip 200 can also be arranged at a corresponding position on the flow directing channel 4 based on the circuit design requirement.

It should be noted that, FIG. 13 is only an exemplary description. The number of the chips 200 in the same chip voltage layer may also be two, four, five, six, or more, and all the chips 200 in the same chip voltage layer are located at the same cross section of the cooling liquid flow channel 2.

In some embodiments, one of the two flow channel openings is provided on the end surface of the radiator body 1 to which the end portion at the other side(the end portion towards the other direction) of the cooling liquid flow channel at one edge of the parallel flow channel extends, and the end portions at the one side (the end portions towards the one direction) of the flow directing channel and the cooling liquid flow channel at the other edge are in communication with each other. For example, in FIG. 12, the first flow channel opening 31 is provided on the end surface of the radiator body 1 to which the cooling liquid flow channel 2 at the upper edge of the parallel flow channel extends towards the left direction, and end portions towards the right direction of the flow directing channel 4 and the cooling liquid flow channel 2 at the lower edge are in communication with each other. With this structure, when the cooling liquid flows into one flow channel opening and out of the other flow channel opening, the cooling liquid can be evenly distributed in each cooling liquid flow channel 2, so that the heat of each chip can be carried away by the cooling liquid flowing through, thereby ensuring the temperature balance of all the chips 200 as a whole and avoiding the possible overheating of chips 200 at some positions because the cooling liquid fails to reach or the flow is insufficient.

FIG. 14 is a schematic cross-sectional diagram of the liquid cooling plate radiator in a specific embodiment. As shown in FIG. 14, in some embodiments, there are a plurality of fin structures inside the cooling liquid flow channel 2, and an extension direction of the fin is consistent with an extension direction of the cooling liquid flow channel 2. The fin structure can increase the contact area between the cooling liquid flow channel 2 and the cooling liquid flowing therein to further improve the heat conducting efficiency of the entire liquid cooling plate radiator.

In addition, in some embodiments, the cross section of the cooling liquid flow channel 2 is rectangular, and the cross-sectional area of the cooling liquid flow channel 2 can be adjusted according to the circulating flow of the cooling liquid to ensure a sufficiently large convective heat transfer coefficient between the cooling liquid and the liquid cooling plate, that is, to ensure the Reynolds number (Re) to be greater than 4000, so that the cooling liquid is in a turbulent flow state in the cooling liquid flow channel 2.

The integrated heat transfer formula for chip heat dissipation is known from the heat transfer science as:

Q=K·A·ΔT

Wherein Q is the amount of heat dissipation (that is, the amount of heat generation of the chip 200), K is the integrated heat transfer coefficient (related to the heat conduction efficiency of the material and the convective heat transfer efficiency between the cooling liquid and the cooling plate), A is the heat transfer area (including the heat conduction area of the chip and the convective heat transfer area between the cooling liquid and the cooling plate), and ΔT is the heat transfer temperature difference (that is, the difference between the chip temperature and the cooling liquid temperature). The above formula shows that when the amounts of heat generation of the chips are the same, ensure that K, A, and the cooling liquid temperature are the same as much as possible, then the temperatures of the chips would be equal. Therefore, based on the theoretical guidance of this formula, the liquid cooling plate radiator in the embodiment of this application realizes that a plurality of chips in the same chip voltage layer are arranged side by side on one cooling liquid flow channel, ensuring that the cooling liquid temperatures corresponding to the plurality of chips in the same chip voltage layer are the same, and the width of the cooling liquid flow channel covers all the chips in the same chip voltage layer, ensuring the heat dissipation areas of the chips in the same chip voltage layer are close. For the same cooling liquid flow channel, in a case that the cooling liquid flows in evenly, when the flow rates of the cooling liquid everywhere in the cooling liquid flow channel are close to each other, the convective heat transfer efficiencies are close. In addition, combined with the circuit design, the peripheral hardware structures of the chips are the same to ensure consistent heat conduction of the peripheral environment, so that the integrated heat transfer coefficients K of the chips in the same chip voltage layer are close. Therefore, the temperatures of the chips in the same chip voltage layer are close.

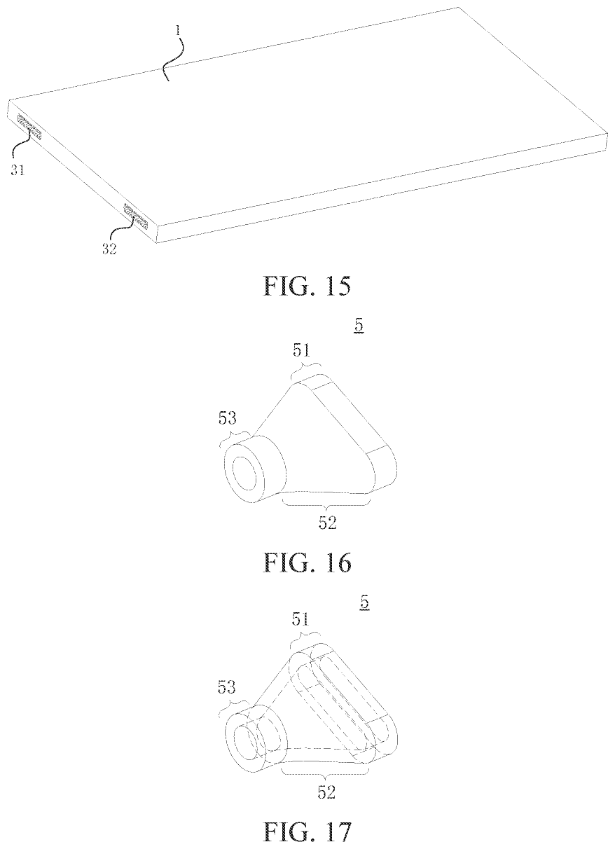

As shown in FIG. 14, since in some embodiments, the cross section of the cooling liquid flow channel 2 in the radiator body 1 is rectangular, and in addition, the cross section of the flow directing channel 4 in some embodiments is also rectangular, the flow channel opening formed by the cooling liquid flow channel 2 and the flow directing channel 4 extending to the end surface of the radiator body 1 is a rectangular structure, as the first flow channel opening 31 and the second flow channel opening 32 shown in FIG. 15. However, cooling liquid delivery pipes outside the liquid cooling plate radiator generally adopt a circular pipe with a circular cross-section, and the circular pipe does not match the cross-sectional area of the cooling liquid flow channel 2 in the embodiment of this application. Therefore, a pipe fitting connector that can match the cooling liquid delivery pipes and the flow channel openings needs to be disposed between the flow channel openings and the cooling liquid delivery pipes outside the liquid cooling plate radiator.

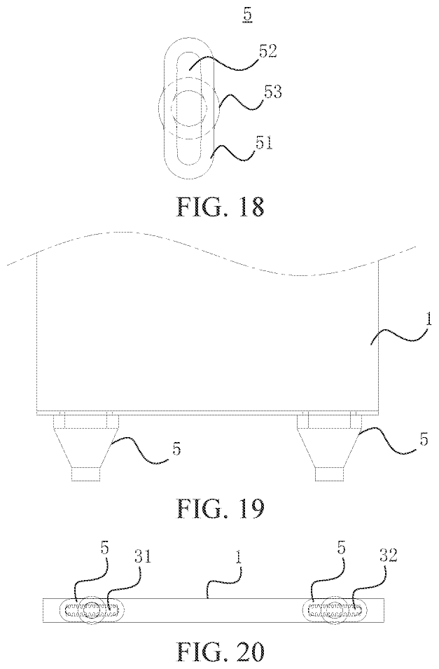

FIG. 16 shows an exterior structure of the pipe fitting connector 5 in the embodiment of this application, FIG. 17 shows a perspective structure of the pipe fitting connector in the embodiment of this application, FIG. 18 shows a perspective structure of the pipe fitting connector from a side of a first connection portion, FIG. 19 shows a top structure of the pipe fitting connector 5 mounted on the radiator body 1, and FIG. 20 shows a perspective structure of the pipe fitting connector 5 mounted on the radiator body 1 with a cooling liquid flow channel 2.

As shown in FIG. 19 and FIG. 20, there are two pipe fitting connectors 5, the two pipe fitting connectors 5 match the two flow channel openings respectively, and the two pipe fitting connectors 5 are mounted at the two flow channel openings respectively. That is, the two pipe fitting connectors 5 match the first flow channel opening 31 and the second flow channel opening 32 respectively, and the two pipe fitting connectors 5 are mounted at the first flow channel opening 31 and the second flow channel opening 32 respectively.

As shown in FIG. 16, FIG. 17, and FIG. 18, the pipe fitting connector 5 has a hollow structure, and the pipe fitting connector 5 includes a first connection portion 51, a transition portion 52, and a second connection portion 53 that are formed integrally. In combination with FIG. 20, a shape of a cross section of an inner hole of the first connection portion 51 matches a shape of the flow channel opening, and the first connection portion 51 is docked with the flow channel opening. The second connection portion 53 matches a connected pipe fitting. A shape of an inner hole of the pipe fitting is different from the shape of the flow channel opening, for example, the shape of the inner hole of the pipe fitting is a circle, and the shape of the flow channel opening is approximately a rectangle or a flat oval. The transition portion 52 is located between the first connection portion 51 and the second connection portion 53. And at a first junction of the transition portion 52 and the second connection portion 53, a cross section of an inner hole of the transition portion 52 has the same shape as a cross section of an inner hole of the second connection portion 53. At a second junction of the transition portion 52 and the first connection portion 51, the cross section of the inner hole of the transition portion 52 has the same shape as the cross section of the inner hole of the first connection portion 51. In the description herein, the first junction and the second junction are used only to distinguish the junction between the transition portion 52 and the second connection portion 53 and the junction between the transition portion 52 and the first connection portion 51. In the transition portion 52, from the first junction (that is, the junction between the transition portion 52 and the second connection portion 53) to the second junction (that is, the junction between the transition portion 52 and the first connection portion 51), the cross section of the inner hole of the transition portion 52 smoothly transits from a shape of the cross section of the inner hole of the second connection portion 53 to the shape of the cross section of the inner hole of the first connection portion 51. In this structure, in the process of the cooling liquid flowing into the transition portion 52 from the second connection portion 53 and then to the first connection portion 51, and in the process of the cooling liquid flowing into the transition portion 52 from the first connection portion 51 and then to the second connection portion 53, the even flow rate of the cooling liquid can be ensured to avoid a local eddy and a local dead zone of the cooling liquid caused by sudden change of the flow channel shape near the flow channel opening, thereby reducing the difference of the flow rates of the cooling liquid at the different places at the same flow channel interface in the cooling liquid flow channel 2 due to this case, and reducing the difference of values of the integrated heat transfer coefficients K of the chips in the same chip voltage layer. At the same time, the structure can also reduce the flow resistance of the cooling liquid caused by the sudden change of the cross section of the flow channel.

The shape of the first connection portion 51 and the shape of the second connection portion 53 match the shape of the flow channel opening and the shape of the pipe fitting respectively. In some embodiments, the shape of the cross section of the inner hole of the first connection portion 51 is a flat oval or a rectangle. For example, for the rectangular flow channel opening in the embodiment of this application, the shape of the cross section of the inner hole of the first connection portion 51 may be a flat oval shown in FIG. 17, FIG. 18, and FIG. 20, or may be a rectangle. In some embodiments, for the commonly used circular pipe fitting, the shape of the cross section of the inner hole of the second connection portion 53 is a circle.

In addition, in some embodiments, according to the requirement of joints for the connected pipe fitting, the second connection portion 53 may be a pagoda joint structure, an external thread structure, an internal thread structure, or a bare pipe structure. The bare pipe structure is a bare pipe structure for welding.

In some embodiments, an axis of the inner hole of the first connection portion 51 coincides with an axis of the inner hole of the second connection portion 53. In this way, it can be ensured that the cooling liquid does not have an uneven flow rate caused by the turning of the path in the pipe fitting connector 5.

An embodiment of this application further provides a computing device, including a PCB board and the liquid cooling plate radiator according to any one of the foregoing embodiments. There are at least two chip voltage layers on one side surface of the PCB board facing the liquid cooling plate radiator, wherein each chip voltage layer comprises at least two chips that are powered in parallel and arranged in a row, the chips are attached to the liquid cooling plate radiator, and the chips are stacked on the cooling liquid flow channel, the chips in the chip voltage layer are arranged in a direction perpendicular to an extension direction of the cooling liquid flow channel, and the chips in each chip voltage layer are located on the same cooling liquid flow channel. Further, the at least two chip voltage layers are distributed along the extension direction of the cooling liquid flow channel.

In the liquid cooling plate radiator and the computing device of the embodiments of this application, the structural design of the cooling liquid flow channel in the radiator body is utilized to ensure that the chips in each chip voltage layer are located on the same cross section perpendicular to the extension direction of the cooling liquid flow channel in the liquid cooling plate radiator. When the cooling liquid in the cooling liquid flow channel flows through the same cross section, the temperature of the cooling liquid thereat is consistent, ensuring that the temperatures of the chips arranged at the same cross section and located in the same chip voltage layer are basically consistent. Therefore, the balanced stability of the operating frequency of each chip in each voltage layer can be facilitated, the optimal operating state can be achieved through adjustment simultaneously, and the performance of the entire electronic computing device can be maximized. In addition, in the embodiments of this application, the flow channel openings provided on the same end surface of the radiator body can reduce the space for arranging the cooling liquid pipeline, and further reduce the occupied space of the computing device, to further miniaturize and integrate the computing device. Meanwhile, based on the structure in which the flow channel openings are provided on the same end surface of the radiator body, the circuit interface of the PCB board attached to the liquid cooling plate radiator can be provided at the other side opposite to the flow channel openings, so that the mutual interference caused by the circuit interface and the flow channel opening located at the same side can be avoided, leaving more space for the circuit interface side, which is also conducive to the management and maintenance of the circuit interface in the PCB board.

The foregoing descriptions are merely exemplary embodiments of this application, but are not intended to limit this application. Any modification, equivalent replacement, or improvement made within the spirit and principle of this application should fall within the protection scope of this application.

1. A liquid cooling plate radiator, comprising:
a radiator body; and
a cooling liquid flow channel located in the radiator body, wherein a width of the cooling liquid flow channel is not less than a width of at least two chips arranged.

2. The liquid cooling plate radiator according to claim 1, wherein on the same end surface of the radiator body, there are two flow channel openings in communication with the cooling liquid flow channel.

3. The liquid cooling plate radiator according to claim 2, wherein there is at least one cooling liquid flow channel, and the cooling liquid flow channel extends straight in the radiator body;
when there are at least two cooling liquid flow channel, the cooling liquid flow channels are arranged parallel to each other.

4. The liquid cooling plate radiator according to claim 3, wherein the number of the cooling liquid flow channels is an even number, and the adjacent cooling liquid flow channels are in communication with each other through their respective end portions to form a serial flow channel;
end portions of two cooling liquid flow channels at a head and at a tail in the serial flow channel extend respectively to the same end surface of the radiator body to form the two flow channel openings, the end portions extending respectively to the same end surface of the radiator body not in communication with other cooling liquid flow channels.

5. The liquid cooling plate radiator according to claim 3, wherein the number of the cooling liquid flow channels is an odd number greater than one, and the adjacent cooling liquid flow channels are in communication with each other through their respective end portions to form a serial flow channel;
an end portion of a cooling liquid flow channel at one end of the serial flow channel extends to an end surface of the radiator body to form one of the two flow channel openings, the end portion extending to the end surface of the radiator body not in communication with other cooling liquid flow channels;
the liquid cooling plate radiator further comprises a flow directing channel located in the radiator body that is adjacent to and parallel to a cooling liquid flow channel at the other end of the serial flow channel;
an end portion of the cooling liquid flow channel at the other end is in communication with one end portion of the flow directing channel, the end portion in communication with one end portion of the flow directing channel not in communication with other cooling liquid flow channels;
the other end portion of the flow directing channel extends to the end surface of the radiator body to form the other of the two flow channel openings.

6. The liquid cooling plate radiator according to claim 3, wherein there is one cooling liquid flow channel;
the liquid cooling plate radiator further comprises a flow directing channel located in the radiator body and parallel to the cooling liquid flow channel;
end portions at one side of the cooling liquid flow channel and the flow directing channel are in communication with each other;
end portions at the other side of the cooling liquid flow channel and the flow directing channel extend to the same end surface of the radiator body to form the two flow channel openings.

7. The liquid cooling plate radiator according to claim 3, wherein there are at least two cooling liquid flow channels;
end portions at one side of the at least two cooling liquid flow channels are in communication with each other, end portions at the other side of the at least two cooling liquid flow channels are in communication with each other, and thus the at least two cooling liquid flow channels form a parallel flow channel;
an end portion at the other side of a cooling liquid flow channel at one edge of the parallel flow channel extends to an end surface of the radiator body to form one of the two flow channel openings;
the liquid cooling plate radiator further comprises a flow directing channel located in the radiator body that is adjacent to and parallel to a cooling liquid flow channel at the other edge of the parallel flow channel;
end portions at the one side of the flow directing channel and the cooling liquid flow channel at the other edge are in communication with each other;
an end portion at the other side of the flow directing channel extends to the end surface of the radiator body to form the other of the two flow channel openings.

8. The liquid cooling plate radiator according to claim 2, further comprising:
two pipe fitting connector, the two pipe fitting connectors adapted respectively to the two flow channel openings and mounted respectively at the two flow channel openings.

9. The liquid cooling plate radiator according to claim 8, wherein the pipe fitting connector is a hollow pipe structure, and the pipe fitting connector comprises a first connection portion, a transition portion, and a second connection portion that are integrally formed; wherein,
a shape of a cross section of an inner hole of the first connection portion matches a shape of the flow channel opening, the first connection portion docked with the flow channel opening;
the second connection portion matches a connected pipe fitting;
the transition portion is located between the first connection portion and the second connection portion; and
at a first junction of the transition portion and the second connection portion, a cross section of an inner hole of the transition portion has the same shape as a cross section of an inner hole of the second connection portion;
at a second junction of the transition portion and the first connection portion, the cross section of the inner hole of the transition portion has the same shape as the cross section of the inner hole of the first connection portion;
in the transition portion, from the first junction to the second junction, the cross section of the inner hole of the transition portion smoothly transits from a shape of the cross section of the inner hole of the second connection portion to the shape of the cross section of the inner hole of the first connection portion.

10. The liquid cooling plate radiator according to claim 9, wherein the shape of the cross section of the inner hole of the first connection portion is a flat oval or a rectangle; and
the shape of the cross section of the inner hole of the second connection portion is a circle.

11. A computing device, comprising:
the liquid cooling plate radiator according to claim 1;
a PCB board provided with at least two chip voltage layers at one side surface thereof facing the liquid cooling plate radiator, wherein each chip voltage layer comprises at least two chips that are powered in parallel and arranged in a row, the chips are attached to the liquid cooling plate radiator, and the chips are stacked on the cooling liquid flow channel, the chips in each chip voltage layer are arranged in a direction perpendicular to an extension direction of the cooling liquid flow channel, and the chips in each chip voltage layer are located on the same cooling liquid flow channel.

12. The computing device according to claim 11, wherein the at least two chip voltage layers are distributed along the extension direction of the cooling liquid flow channel.
